(19) United States
(12) Patent Application Publication
(10) Pub. No.: US 2025/0148887 A1
(43) Pub. Date: May 8, 2025

(54) CUSTOMER SECURITY STATUS AWAY SELECTIONS_2

(71) Applicant: Jessica Latrice Patterson, Southgate, MI (US)

(72) Inventor: Jessica Latrice Patterson, Southgate, MI (US)

(21) Appl. No.: 18/500,973

(22) Filed: Nov. 2, 2023

(51) Int. Cl. G08B 13/00; G08B 25/00

(52) U.S. Cl. CPC G08B 13/00; G08B 25/008

(57) ABSTRACT

Methods and system statuses are disclosed for identifying false alarms and indicating the level of security monitoring company and emergency response needed when the primary end-user is away. Aspects include bypassing sensor data, and ranking sensor data based on where the sensor is located at the home.

### TECHNICAL FIELD

Some implementations relate generally to remote residential surveillance, and more particularly, to communicating various away statuses to remote residential surveillance monitoring companies.

### BACKGROUND

Home surveillance systems are increasingly prevalent and allow end-users to control and input status information for those devices. Systems and methods are detailed hereinto provide users flexibility and convenience with respect to controlling status information when away from the home.

### SUMMARY

Some implementations can include a method useful for reducing false alarm events that trigger a security or emergency service response. The disclosed methods and systems give end-users the ability to indicate the level of response needed if there is a triggering event. Some alarm events would warrant monitoring company response, some would warrant emergency personnel response, others would warrant no response at all.

Away Pet Home is an option that will allow end-user with pet(s) to select when leaving pet(s) alone in the house instead of choosing the Home/Stay selection. This will allow the end-user to have to correct standard of security rather than a security company believing they or someone is still in the home. “Away/Pet Home” will activate sensors and/or cameras within the perimeter of the home to anticipate movement from a pet, but the security company will be notified that the end-user (homeowner) is no longer present in the home. With this proper level of security if there is an external breach of home the security company can better determine what assistance is needed by contacting the end-user (homeowner).

Away Elderly Home this option allows the end-user to select if an Elderly is still roaming at the home so that sensor and/or cameras will anticipate movement. With this level of security, if there is a breach externally, such as a broken window etc. the security company would notify the end-user, stating that an external sensor was activated for the end-user to determine if assistance is needed. If the end-user is unable to reach the Elderly person within the home, it is possible to check the security camera via phone. If emergency personnel is needed the security company is notified by selecting a panic button via phone or by the elderly person under stress.

Away Children Home this is an option for an end-user who may have children on site. The security company is informed that children are home, but the end-user(s) are not. If the end-user is a child that has input their own personal security code to deactivate the current alarm status away, the child specific code has the capability to inform the end-user that the child is home. The child specific security code also informs the security company that a child is home but the adult end-users are away. This also applies if the end-user has hired a third party to watch the child(ren) until a primary, adult end-user(s) arrived home. The internal sensors and camera will anticipate movement within the home. If there is an external breach of the home, the security company notifies the primary end-user(s) who then confirm and send the proper authority to ensure the safety of the children if needed.

Away Guest Home is an option for the primary end-user(s) who occasionally has visitors for short periods of time, but at times will step out while the visitor is still in the home. Form most primary end-user(s), especially those living by themselves, would indeed have the habit of selecting “away” when leaving the house which would activate the sensors and camera not to anticipate movement internally to the home. If there is activity, the primary end-user would potentially receive a call from the security company who believes there is a breach within the home. This would be a false alarm. This status would allow the guest to roam freely without false alarms.

Keypad Displays “Away” Selections is a keypad showing a display screen with the additional “Away” Selections for the end-users to select such as “Away Pet”, “Away Elderly”, “Away Child” or “Away Guest” to inform the security company who is home while the end-user is away.

Touch Screen Security Selection: the touch screen displays will show the end-user the main security screen. When the end-user selects “Away” on the main screen the “Away Security Selection” will appear for the end-user to select which away option needed when the end-user is leaving the home. These include “Away Pet,” “Away Elderly,” “Away Child,” or “Away Guest” to inform the security company who is home while the primary end-user(s) is away.

### BRIEF DESCRIPTION OF THE DRAWINGS

FIG. 1 is a diagram of an example flowchart in accordance with the disclosure.

FIG. 2 is a flowchart of an example method of “Away Pets Home” in accordance with some implementations.

FIG. 3 is a flowchart of an example method of “Away Elderly Home” in accordance with some implementations.

FIG. 4 is a flowchart of an example method of “Away Children Home” in accordance with some implementations.

FIG. 5 is a flowchart of an example method of “Away Guest Home” in accordance with some implementations.

FIG. 6 is an example comparing a current keypad displays for home security vs. a keypad display containing additional Away Features.

FIG. 7 shows an example of selecting Away Features from the main Security screen to the Away Security Screen.

FIG. 8 shows a digital image of a basic touch screen that shows the additional Away Status.

FIG. 9 shows a digital image of an advance touch screen home security system unarmed.

FIG. 10 shows a digital image of an advance touch screen home security system armed for “Away Children”. This is an example of an activated system.

FIG. 11 shows digital image of an advance touch screen home security system unarmed with a camera view.

FIG. 12 shows a digital image of an advance touch screen home security system armed for “Away Children” with a camera view. This is an example of an activated system.

### DETAILED DESCRIPTION

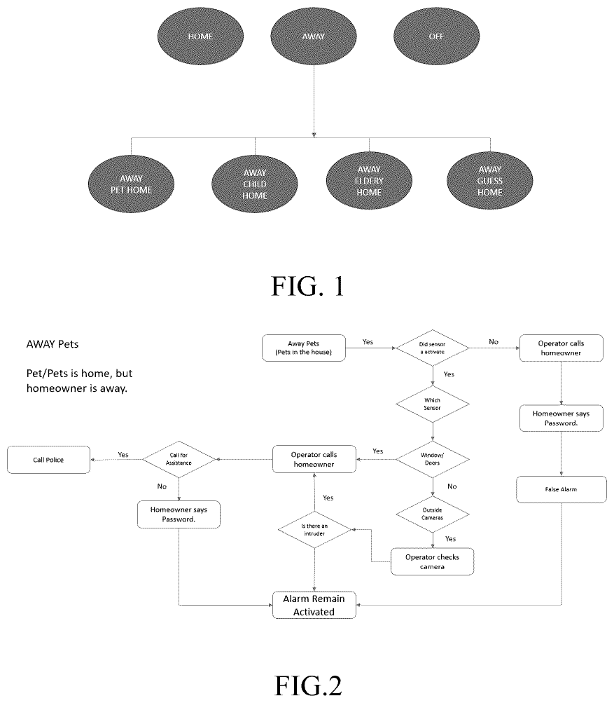

FIG. 1 is an example of an updated residential surveillance system selection screen. Once a person has selected “Away” the additional methods of away would populate the screen to determine the proper level of security that is needed.

FIG. 2 is a flowchart that describes a process flow for “Away Pet Home” when there is a breach of security what is the additional steps to determine if breach is a false alarm or if help is needed such as the police, ambulance or fire department.

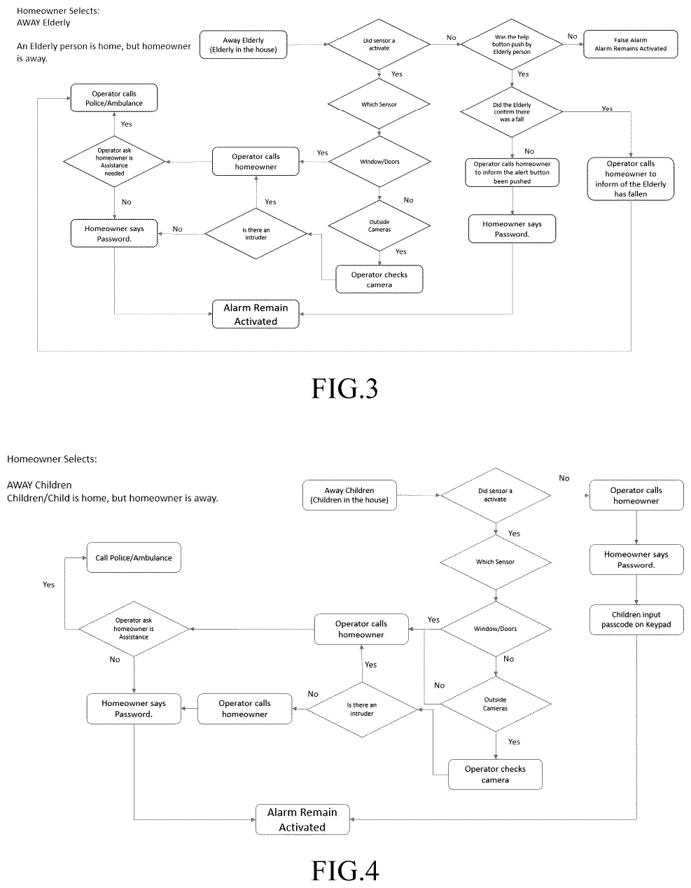

FIG. 3 is a flowchart that describes a process flow for “Away Elder Home” when there is a breach of security what is the additional steps to determine if breach is a false alarm or if help is needed such as the police, ambulance or fire department.

FIG. 4 is a flowchart that describes a process flow for “Away Children Home” when there is a breach of security what is the additional steps to determine if breach is a false alarm or if help is needed such as the police, ambulance or fire department.

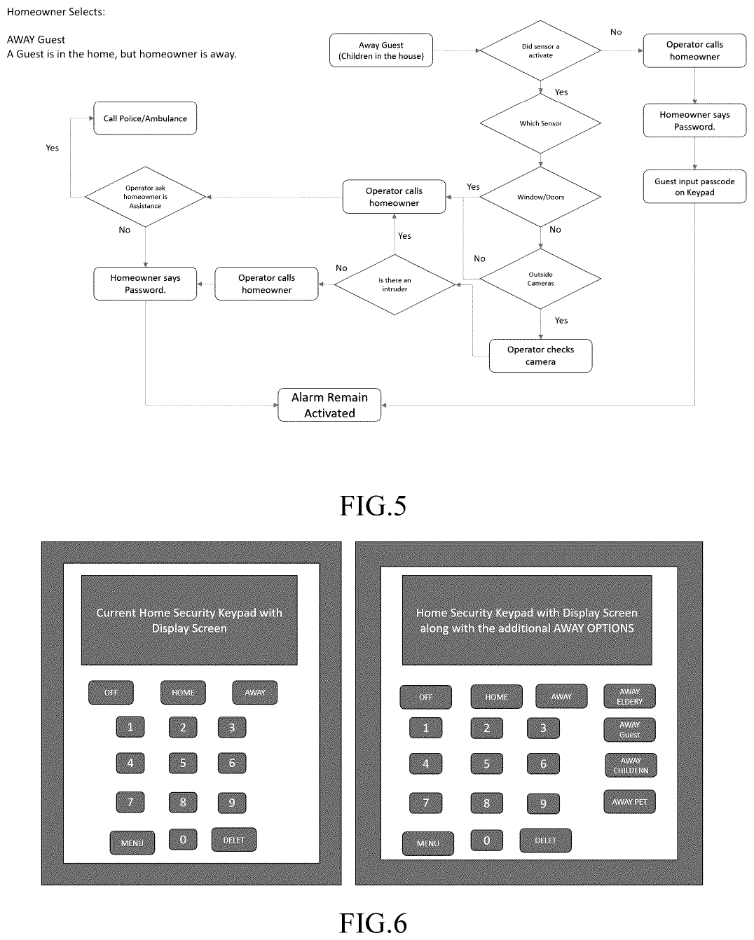

FIG. 5 is a flowchart that describes a process flow for “Away Guest Home” when there is a breach of security what is the additional steps to determine if breach is a false alarm or if help is needed such as the police, ambulance or fire department.

FIG. 6 shows the new version of keypads with additional Away Status along with a display screen.

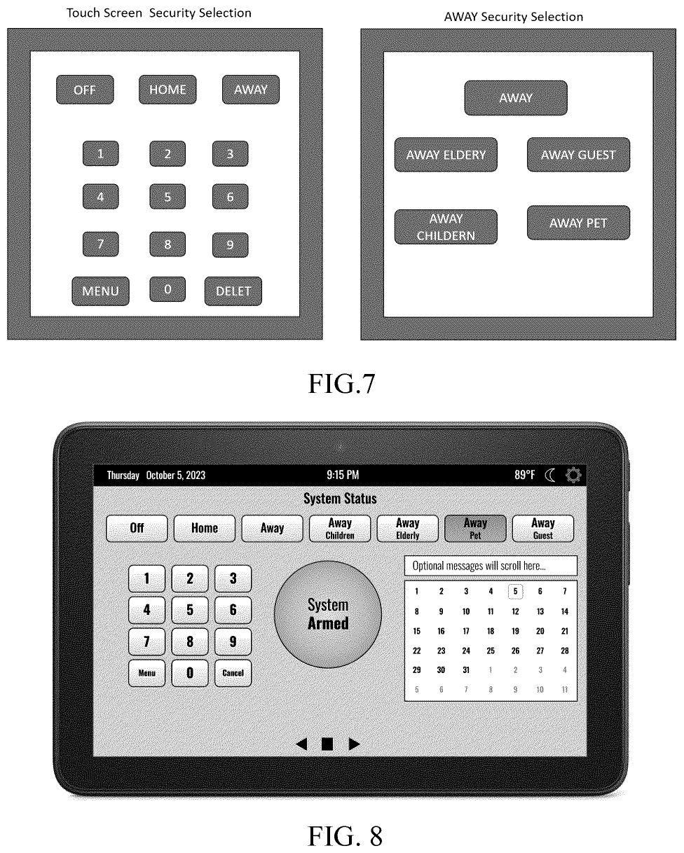

FIG. 7 shows the Main Security and the Away Security with the additional options of away selections within a touch screen.

FIG. 8 shows a basic digital image of a touch screen showing a home security system armed for “Away Pet” as an example armed system. The touch screen has a keypad with the capability to disarm the home security system via a unique code.

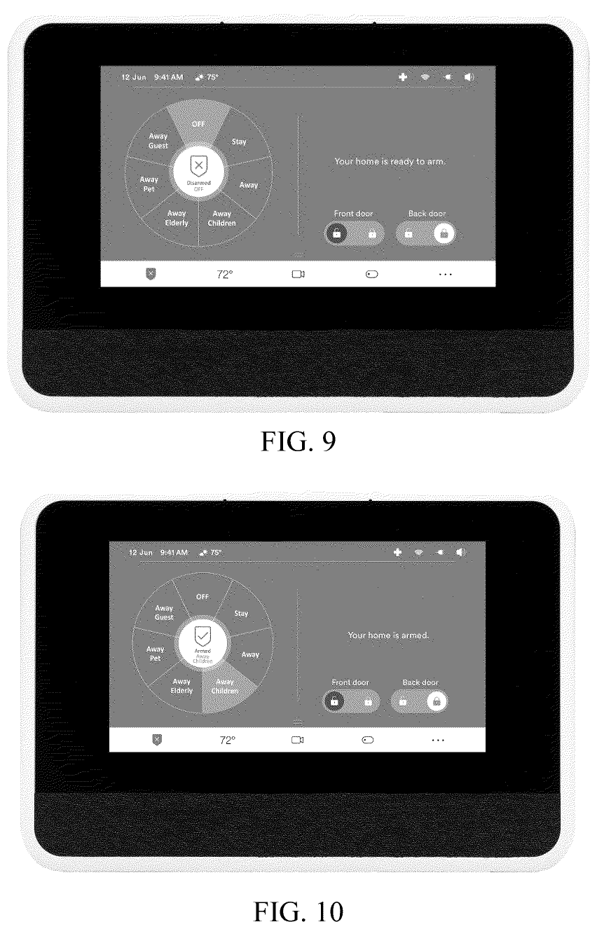

FIG. 9 shows a digital image of an unarmed advanced home security touch screen with traditional status indicators, plus additional Away Status indicators with smart lock(s) capability for multiple entry points.

FIG. 10 shows a digital image of an advanced home security touch screen with traditional status indicators, plus additional Away Status indicators with smart lock(s) capability for multiple entry points. This is an example of an activated system set as “Away Children”.

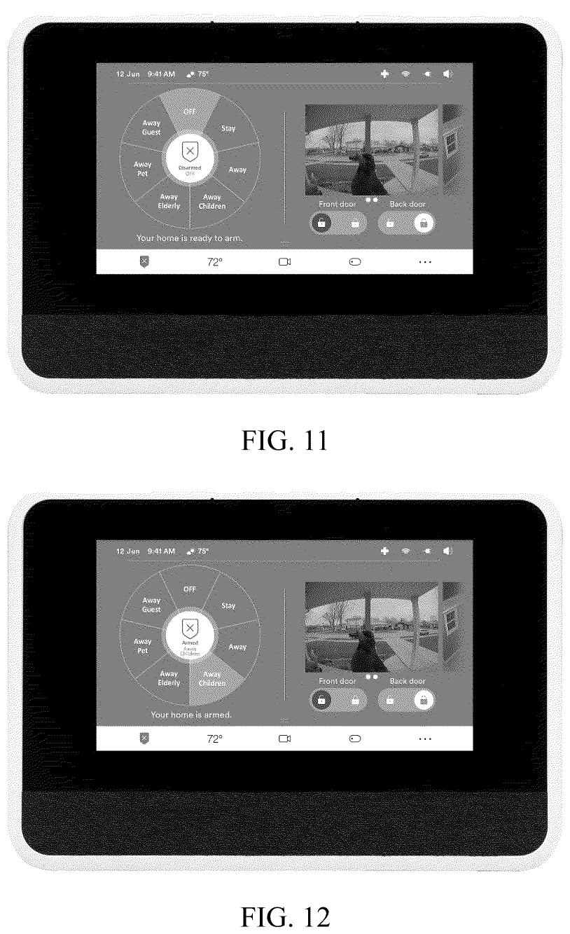

FIG. 11 shows a digital image of an unarmed advance home security touch screen with traditional status indicators, plus additional Away Status indicators with a camera view and smart lock(s) capability for multiple entry points.

FIG. 12 shows a digital image of an advance home security touch screen with traditional status indicators, plus additional Away Status indicators with a camera view smart lock(s) capability for multiple entry points. This is an example of an activated system set as “Away Children”.

What is claimed is:

1. A method comprising:
A bypass of internal home surveillance sensors indicating a security breach. A transmission of internal sensor data that does not trigger a security response unless perimeter sensors are first breached.

2. A method of nuanced “away” statuses, the method comprising:
Distinct statuses that alert the residential monitoring company of the level of response needed when internal sensors are triggered.
